(19) United States
(12) Patent Application Publication
(10) Pub. No.: US 2008/0250946 A1
(43) Pub. Date: Oct. 16, 2008

(54) BREAD DECRUSTER

(76) Inventor: Tamara Monosoff, Walnat Creek, CA (US)

Correspondence Address: WEST & ASSOCIATES, A PC, 2815 MITCHELL DRIVE, SUITE 209, WALNUT CREEK, CA, 94598, US

(21) Appl. No.: 11/923,603

(22) Filed: Oct. 24, 2007

Related U.S. Application Data
(60) Provisional application No. 60/862,766, filed on Oct. 24, 2006.

(51) Int. Cl. A47J 17/00

(52) U.S. Cl. 99/567; 99/537

(57) ABSTRACT

An apparatus for separating a central portion of piece of bread from a crust portion of said piece bread.

### CLAIM OF PRIORITY

This application claims the U.S. Provisional Application No. 60/862,766 filed Oct. 24, 2006, the complete contents of each of which is incorporated herein by reference.

### BACKGROUND

This patent application relates, generally, to apparatus for separating bread from its crust.

Children often request that their sandwiches be served without the crust of the bread. Thus, parents spend an exorbitant amount of time and energy in removing the crusts from children's sandwiches.

Elegant occasions also dictate that small bit-sized sandwiches, often referred to as finger sandwiches be served. Catering staff and/or party hosts can spend many hours both removing crusts from sandwiches and cutting the remaining large sandwich into smaller and/or intricate and interesting shapes which will be visually appealing to guests.

What is needed is an apparatus which will allow a user to quickly and efficiently remove the crust from sandwiches and, in some cases, cut the remaining sandwich in to desired shapes.

### BRIEF DESCRIPTION OF THE DRAWINGS

FIG. 1 depicts one embodiment of a bread decruster.

FIG. 2 depicts an alternate embodiment of the bread decruster shown in FIG. 1.

FIG. 3 depicts an alternate embodiment of the bread decruster shown in FIG. 1.

FIG. 4 depicts an alternate embodiment of the bread decruster shown in FIG. 1.

FIG. 5 depicts an alternate embodiment of the bread decruster shown in FIG. 1.

FIG. 6 depicts an alternate embodiment of the bread decruster shown in FIG. 1.

FIG. 7 depicts an alternate embodiment of the bread decruster shown in FIG. 1.

FIG. 8 depicts an alternate embodiment of the bread decruster shown in FIG. 1.

FIG. 9 depicts an alternate embodiment of the bread decruster shown in FIG. 1.

FIG. 10 depicts an alternate embodiment of the bread decruster shown in FIG. 1.

FIG. 11 depicts an alternate embodiment of the bread decruster shown in FIG. 1.

### DETAILED DESCRIPTION

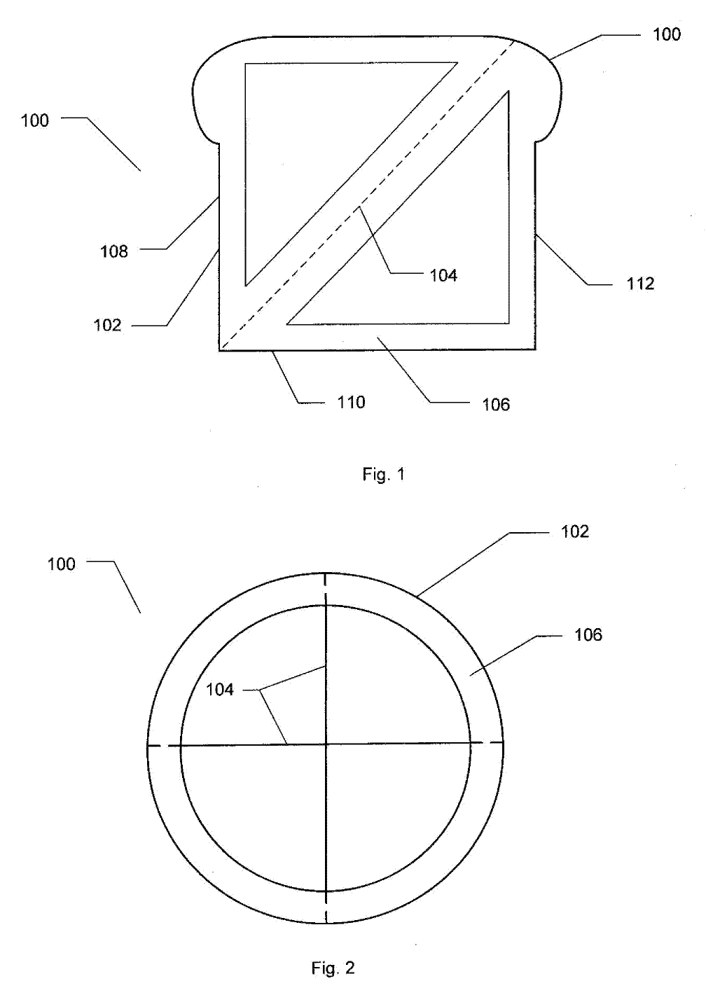

FIG. 1 depicts an embodiment of a bread decruster 100. In the embodiment shown in FIG. 1, the bread decruster 100 includes a perimeter blade 102, a divider blade 104 and a handle 106.

In the embodiment shown in FIG. 1, the perimeter blade 102 is depicted as having a shape that approximates the shape of standard baked bread, having three substantially straight edges 108, 110, 112 and one semi-circular edge 114 at the top. In the embodiment shown in FIG. 1, the perimeter blade 102 of the bread decruster 100 has dimensions such that the entirety of the perimeter blade 102 can fit within the perimeter of a standard piece of baked bread. However in alternate embodiments, the perimeter blade 102 can have any known and/or convenient geometry and/or dimensions.

In the embodiment shown in FIG. 1, the divider blade 104 is oriented such that the divider blade 104 can divide the interior of the sandwich into two substantially equal portions. In the embodiment shown in FIG. 1, the divider blade 104 is oriented diagonally relative to the perimeter blade-running from the intersection of the semi-circular blade 114 and one substantially straight edge 108 to the intersection of the other two edges 110, 112. Although depicted in a diagonal orientation in the embodiment shown in FIG. 1, in alternate embodiments the divider blade 104 can be located in any convenient location within the perimeter blade 102 and can divide the remaining sandwich into any two convenient shapes having any relative shapes, dimensions and sizes. In still further alternate embodiments, the divider blade 104 may not be present. In further alternate embodiment, the bread decruster 100 can include any convenient number of divider blades 104 that can be arranged to cut the interior of the sandwich into any known and/or convenient shapes.

In the embodiment shown in FIG. 1, the handle 106 is depicted as being integral with the perimeter blade 102 and the divider blade 104. However, in alternate embodiments, the handle 106 can be integral with any convenient portion of the perimeter blade 102 and/or divider blade 104. In still further alternate embodiments, the handle 106 can be a separate item coupled with and/or selectively couplable any convenient portion of the bread decruster 100 and/or may be absent.

In the embodiment shown in FIG. 1, the bread decruster 100 can be an integrated unit made from a food-grade plastic. However, in alternate embodiment the device can be comprised of various components made from any know and/or convenient material.

In the embodiment shown in FIG. 2, the bread decruster 100 can have a perimeter blade 102 that is substantially circular. In the embodiment shown in FIG. 2, the perimeter blade 102 can have dimensions such that the perimeter blade 102 has a diameter such that the perimeter blade 102 will fit within the confines of the perimeter of a standard piece of baked bread. However, in alternate embodiments, the perimeter blade 102 can have any known and/or convenient geometry and/or dimensions.

In the embodiment shown in FIG. 2, the bread decruster 100 includes a handle 106 and two divider blades 104. However in alternate embodiments, the bread decruster 100 can include any desired number of divider blades 104 capable of dividing the interior of the sandwich into any number of known and/or convenient shapes having any convenient geometries and/or dimensions and/or no divider blades 104.

In the embodiment shown in FIG. 2, the handle 106 is substantially equal to the diameter of the perimeter blade 102 However in alternate embodiments, the handle can be positioned in any convenient location relative to the perimeter blade 102 and/or and/or divider blades 104 (if present) and/or can be absent.

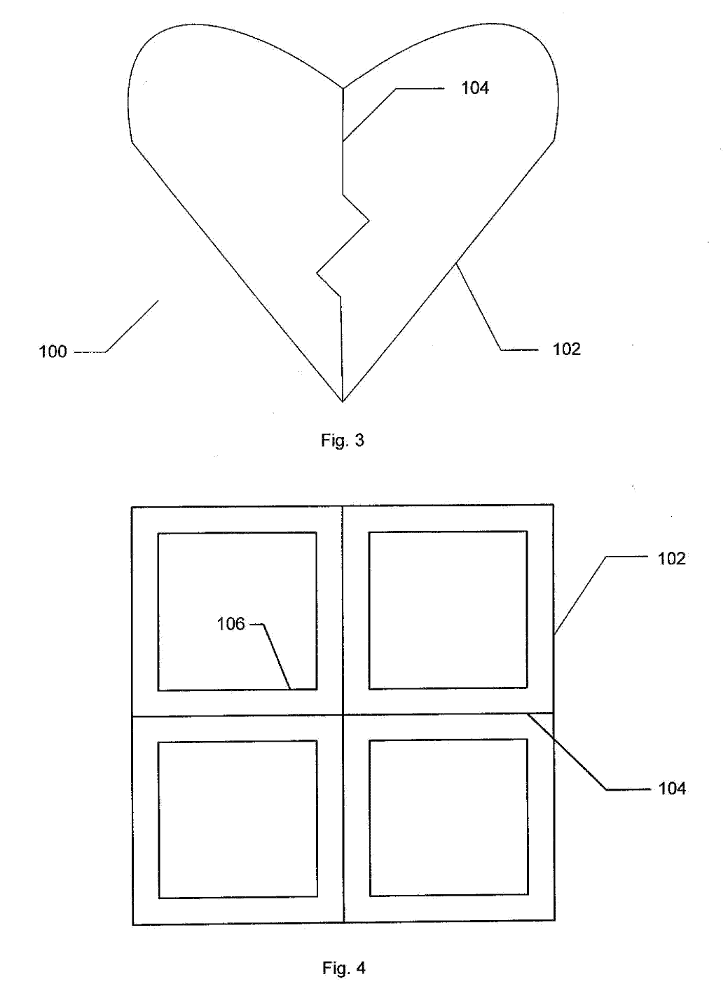

FIG. 3 depicts an alternate embodiment of the bread decruster 100 shown in FIG. 1. In the embodiment shown in FIG. 3, the perimeter blade 102 is substantially in the shape of a heart. In some embodiments the bread decruster 100 can include a divider blade 104 which can divide the heart shaped interior of the sandwich into any two convenient pieces. In some embodiments, the divider blade 104 can configured to produce a jagged edge such the two portions of the sandwich appear to be broken. However in alternate embodiments, the divider blade 104 can be a standard straight blade and/or have any convenient shape and/or configuration and/or orientation desired. Moreover is some embodiments, the decruster 100 can be made with or without a handle or handles 106.

In still further alternate embodiment of the embodiment shown in FIG. 3, the bread decruster 100 can include two or more divider blades 104 and the interior of the sandwich can be divided into any number of convenient pieces having any known and/or convenient geometry and/or dimensions.

In some embodiments the bread decruster 100 depicted in FIG. 3 can include a handle and/or the handle may be absent.

FIG. 4 depicts an alternate embodiment of the bread decruster depicted in FIG. 1. In the embodiment shown in FIG. 4, the perimeter blade 102 is in the shape of a square. In the embodiment shown in FIG. 4, the bread decruster 100 can include a divider blade and/or blades 104 and/or a handle or handles 106. In some embodiments, the perimeter blade 102 and/or handle 106 can have rounded corners and/or any desired geometric configuration.

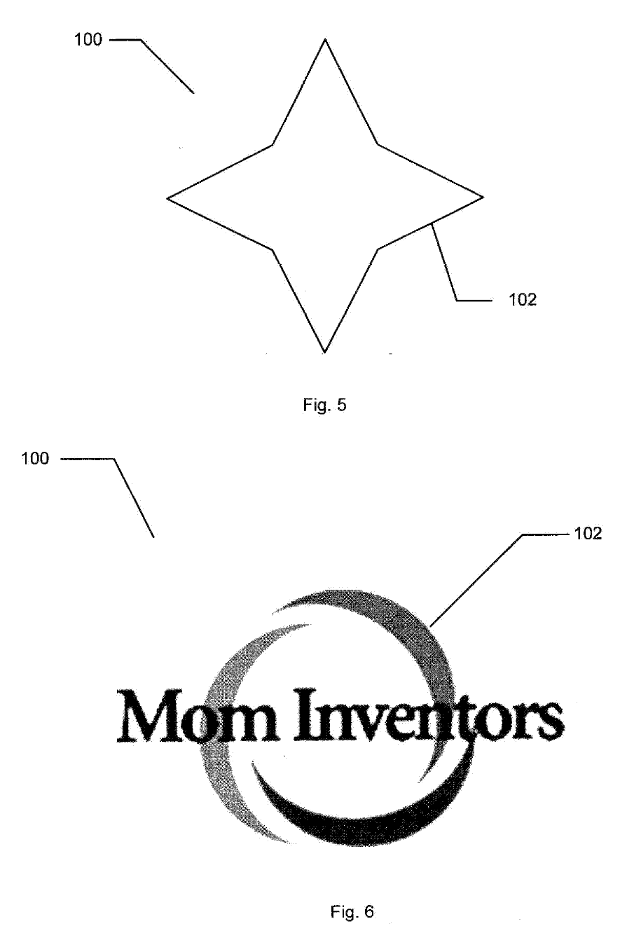

FIG. 5 depicts an alternate embodiment of the bread decruster depicted in FIG. 1. In the embodiment shown in FIG. 5, the perimeter blade 102 is in the shape of a star. In some embodiments, the star can have 4 points, 5 points and in other embodiments the star can have 6 points. In still further alternate embodiments, the star can have any known and/or convenient number of points and can have regular and/or irregular geometry and/or dimensions. In further alternate emboidiments, the bread decruster can include divider blades 104 and/or a handle 106, each of which may be integral and/or coupled with the bread decruster in any known and/or convenient manner.

FIG. 6 depicts an alternate embodiment of the bread decruster depicted in FIG. 1. In the embodiment shown in FIG. 6, the perimeter blade 102 and/or divider blades 104 can be in the shape of one or more logos and/or desired text. In further alternate emboidiments, the bread decruster can include divider blades 104 and/or a handle 106, each of which may be integral and/or coupled with the bread decruster in any known and/or convenient manner.

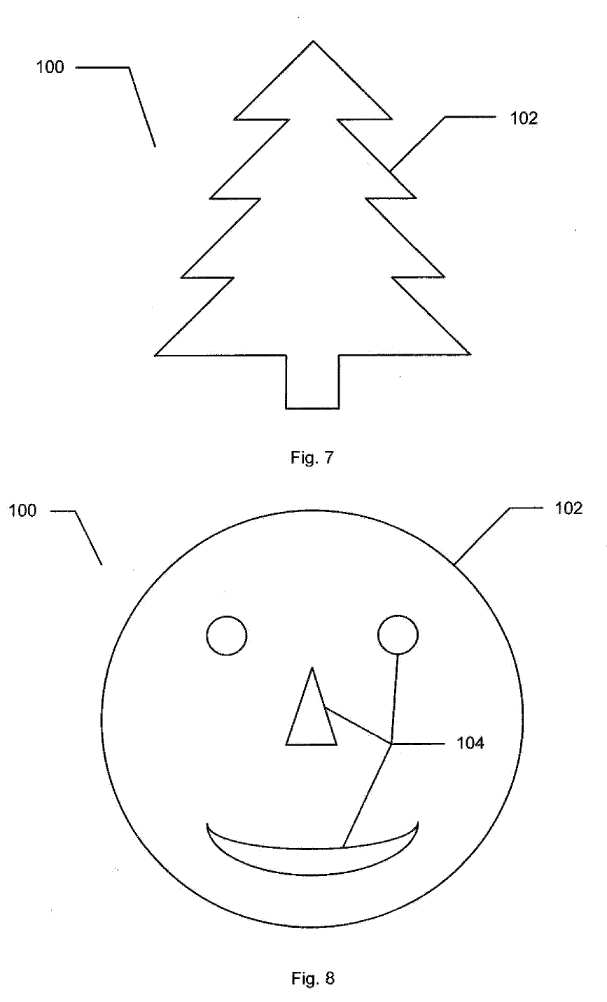

FIG. 7 depicts an alternate embodiment of the bread decruster depicted in FIG. 1. In the embodiment shown in FIG. 7, the perimeter blade 102 and/or divider blades 104 can be in the shape of one or more Christmas trees and/or other holiday shapes and/or desired shapes. In further alternate emboidiments, the bread decruster can include divider blades 104 and/or a handle 106, each of which may be integral and/or coupled with the bread decruster in any known and/or convenient manner.

FIG. 8 depicts an alternate embodiment of the bread decruster depicted in FIG. 1. In the embodiment shown in FIG. 8, the perimeter blade 102 and/or divider blades 104 can be in the shape of one or more faces and/or desired images. In further alternate emboidiments, the bread decruster can include divider blades 104 and/or a handle 106, each of which may be integral and/or coupled with the bread decruster in any known and/or convenient manner.

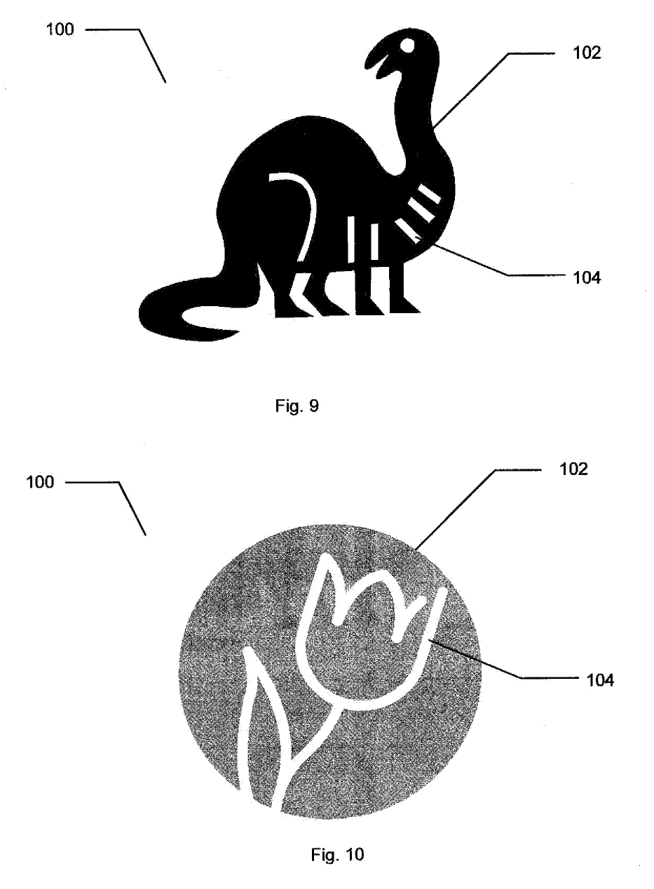

FIG. 9 depicts an alternate embodiment of the bread decruster depicted in FIG. 1. In the embodiment shown in FIG. 9, the perimeter blade 102 and/or divider blades 104 can be in the shape of one or more dinosaurs. In further alternate emboidiments, the bread decruster can include divider blades 104 and/or a handle 106, each of which may be integral and/or coupled with the bread decruster in any known and/or convenient manner.

FIG. 10 depicts an alternate embodiment of the bread decruster depicted in FIG. 1. In the embodiment shown in FIG. 10, the perimeter blade 102 and/or divider blades 104 can be in the shape of one or more flowers. In further alternate emboidiments, the bread decruster can include divider blades 104 and/or a handle 106, each of which may be integral and/or coupled with the bread decruster in any known and/or convenient manner.

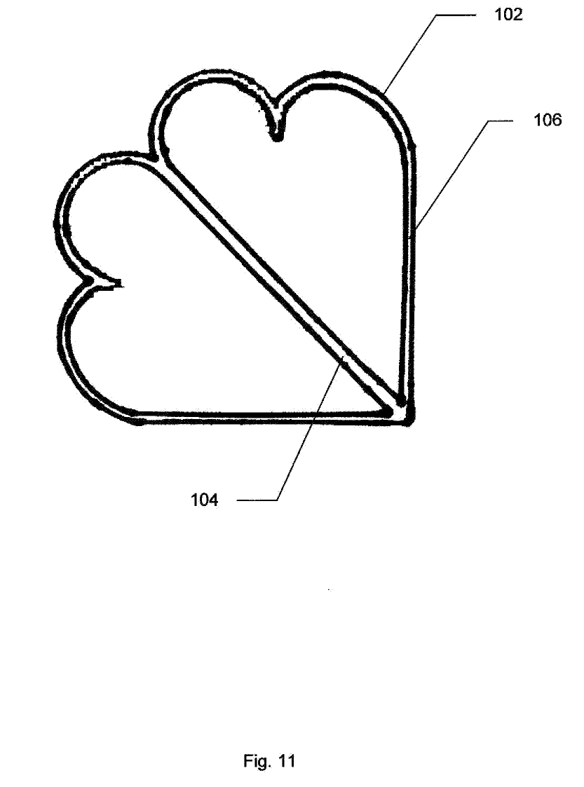

FIG. 11 depicts an alternate embodiment of the bread decruster shown in FIG. 1. In the embodiment depicted in FIG. 11, the perimeter blade 102 and divider blade 104 can be configured to define two complementary heart-shaped chambers. In further alternate emboidiments, the bread decruster can include additional and/or alternately configured divider blades 104 and/or a handle 106, each of which may be integral and/or coupled with the bread decruster in any known and/or convenient manner.

It should be understood that the particular embodiments described above are only illustrative of the principles of the present invention, and various modifications could be made by those skilled in the art without departing from the scope and spirit of the invention. Thus, the scope of the present invention is limited only by the claims that follow.

1-10. (canceled)

11. An apparatus comprising:
a perimeter blade adapted and configured to cut a piece of bread such that a crust of said bread is separated from a central portion of said bread; and
a divider blade operatively coupled with the perimeter blade;
wherein the perimeter blade and divider blade are configured to define two complimentary heart-shaped chambers.

12. The apparatus of claim 11 wherein at least one of the perimeter blade and the divider blade are comprised of food-grade plastic.

13. The apparatus of claim 11 wherein the perimeter blade is configured in a heart shape.

14. An apparatus comprising:
a perimeter blade adapted and configured to cut a piece of bread such that a crust of said bread is separated from a central portion of said bread wherein the perimeter blade is configured in the shape of a dinosaur.

15. The apparatus of claim 14 further comprising a divider blade operatively coupled with the perimeter blade

16. The apparatus of claim 15 wherein the perimeter blade is comprised of food-grade plastic.
